(19) United States
(12) Patent Application Publication
(10) Pub. No.: US 2015/0272132 A1
(43) Pub. Date: Oct. 1, 2015

(54) NEEM OIL GRANULE WITH NUTRIENTS

(71) Applicants: Pieter W. Booysen, St. Augustine, FL (US); Ronald R. Shingler, Blakely, GA (US); Robert L. Thompson, Arlington, GA (US)

(72) Inventors: Pieter W. Booysen, St. Augustine, FL (US); Ronald R. Shingler, Blakely, GA (US); Robert L. Thompson, Arlington, GA (US)

(21) Appl. No.: 14/672,116

(22) Filed: Mar. 28, 2015

Related U.S. Application Data
(60) Provisional application No. 61/972,409, filed on Mar. 30, 2014.

(51) Int. Cl. A01N 65/26; B05D 1/00; C05G 3/02; B05D 1/02; A01N 25/12; A01N 25/24

(52) U.S. Cl. CPC A01N 65/26; A01N 25/12; A01N 25/24; C05G 3/02; B05D 1/02; B05D 1/002

(57) ABSTRACT

A pesticide granule containing neem oil is provided. A biodegradable carrier granule is coated with neem oil and silica or a similar drying agent. The granule preferably contains a blend of nutrients and other ingredients beneficial to crops. The granules have a relatively dry exterior and are free-flowing. The granules are applied to crops by placing the granules into the seed furrows at the time of seed planting or otherwise incorporating the granules into the soil.

### CROSS REFERENCES

This application claims the benefit of U.S. Provisional Application No. 61/972,409, filed on Mar. 30, 2014, which application is incorporated herein by reference.

### FIELD OF THE INVENTION

A preferred embodiment of the invention is directed to a granule comprising neem oil and a method of making the granule.

### BACKGROUND

Azadirachta indica, also known as neem, nimtree, and Indian Lilac, is a tree in the mahogany family Meliaceae. It is one of two species in the genus Azadirachta and is native to India, Pakistan, and Bangladesh, growing in tropical and semi-tropical regions. Neem oil is a vegetable oil pressed from the fruits and seeds of the neem tree. The oil can be obtained through pressing (crushing) of the seed kernel both through cold pressing or through a process incorporating temperature controls. Neem oil can also be obtained by solvent extraction of the neem seed, fruit, oil, cake, or kernel. Generally, the cold pressed oil is of the highest quality.

Neem oil varies in color; it can be golden yellow, yellowish brown, reddish brown, dark brown, greenish brown, or bright red. It is hydrophobic in nature. Neem oil is composed mainly of triglycerides and contains many triterpenoid compounds. Azadirachtin is the most well known and studied triterpenoid found in neem oil. The azadirachtin content of neem oil varies from 300 ppm to over 3750 ppm depending on the extraction technology and quality of the neem seeds crushed. Azadirachtin is an extremely important compound as it is known to be toxic to numerous species of insects yet has very low toxicity to mammals. Neem oil also contains steroids (campesterol, beta-sitosterol, stigmasterol).

Neem oil has many uses, but is used in organic farming as a biopesticide, as it repels a wide variety of pests including mealybugs, beet armyworms, aphids, cabbage worms, thrips, whiteflies, mites, fungus gnats, beetles, moth larvae, mushroom flies, leafminers, caterpillars, locusts, nematodes, Japanese beetles, and others. Furthermore, neem oil can be used as a household pesticide for ants, bedbugs, cockroaches, houseflies, sand flies, snails, termites, and mosquitoes, both as a repellant and a larvicide. Neem oil also controls black spot, powdery mildew, anthracnose and ruse fungi.

Generally, neem oil works by coating plant surfaces and roots, therefore preventing fungal spore germination and killing external fungi on leaf surfaces. Thorough coverage is important. As an insecticide/miticide, it suffocates insects and mites on contact and is especially effective on whiteflies, aphids and other soft-bodied insects. Neem oil also acts as a repellent.

Traditionally, neem seeds are ground into a powder that is soaked overnight in water and sprayed onto the crop. To be effective, it is necessary to apply repeatedly. Neem oil does not directly kill insects on the crop. It acts as an anti-feedant, repellant, and egg-laying deterrent, protecting the crop from damage. Neem oil also suppresses the hatching of pest insects from their eggs.

Currently, treating commercial size farms with neem oil is not cost effective for many reasons. This is primarily because neem oil requires many applications. Furthermore, the viscous neem oil is difficult to apply. Additionally, most commercial crop treatment applications focus on granular applications of pesticides, in which pesticide granules are incorporated into the soil, as opposed to spraying pesticides directly onto crops.

In addition, most insecticides, pesticides, nematicides, and other plant treatments are quite harmful to the environment, animals, humans, and other plants. For example, aldicarb is a carbamate insecticide that is the active ingredient in a granular pesticide called Temik. As with neem, it is effective against thrips, aphids, spider mites, lygus, fleahoppers, and leafminers, but is primarily used as a nematicide. The EPA put a ban in place in 2010 requiring an end to distribution of Temik. For humans, aldicarb is one of the most toxic insecticides used on field crops. Additionally, these products are closely regulated because their potential for ground water and food crop contamination.

In Florida, for example, Temik was used primarily on potatoes, cotton, peanuts, and soybeans. Approval from the Florida Department of Agriculture is required before any applications are made. Anyone applying Temik in Florida is required to obtain a permit from the Florida Department of Agriculture and Consumer Services for each application to be made.

Because Temik is no longer available, growers have access to nematode-tolerant varieties and two other chemicals, Telone and Vydate, but all of the current options are more expensive than Temik had been. Additionally, the currently available chemicals still harmfully affect the environment and other plants.

Alternative methods of nematode control include: nematicide seed treatments (Aeris, Avicta), fumigation (Telone II, Vapam), crop rotation (peanut), and using partially resistant cultivators (Deltapine 175RF, Phytogen (PHY) 367 WRF, ST 5458B2RF).

As set forth above, neem oil is a rather viscous liquid; therefore, applying it to plants is rather difficult. Currently, the generally accepted method of applying neem oil to plants comprises diluting a small amount (approximately one ounce) of neem oil in a larger amount (approximately one gallon) of water. This mixture is then sprayed onto plants. Because neem oil does not kill insects directly, but rather inhibits feeding, growth, and egg production, it is critical that additional applications be administered to the plants. The number of weekly applications varies based on the plant, and may vary from two applications to five or more applications per week.

On the other hand, as mentioned above, many farmers, especially cotton producers, previously used Temik to manage nematode problems. When using Temik, a farmer simply drills granules just below the seed line or places the granules in the seed furrow and covers with soil. Generally, no other Temik applications were required.

As noted from the foregoing, there are problems that exist in the art relating to current methods of neem oil application for farming purposes. Additionally, these and other problems generally exist in the field relating to use of neem oil in farming and gardening.

Thus, a need exists in the art for a granular pesticide that is not toxic to the environment, animals, humans, and other plants. Additionally, a need exists in the art for a neem oil-based pesticide that can be applied to plants more effectively and less frequently than current methods of spraying diluted neem oil directly onto plants. Furthermore, a need exists in the art for a neem oil-based pesticide that can be applied to crops in a manner familiar to commercial farmers.

### SUMMARY

A preferred embodiment of the invention is directed to a pesticide granule comprising neem oil containing azadirachtin. The granule can be applied to plants by placing the granules in the seed furrow or otherwise incorporating the granule into the soil in which crops grow. The granule provides a slow release of neem oil that can be absorbed into the plants over time so that the pesticide does not need to be applied to crops frequently.

In order to manufacture and/or synthesize the granule, neem oil is applied onto a carrier granule. Silica or a similar drying agent is then applied to the exterior of the carrier granule that has been coated with neem oil. This process produces a free-flowing granule having a relatively dry exterior even though the granule comprises neem oil. In a preferred embodiment, the granule further comprises a blend of nutrients and other ingredients beneficial to crops.

Accordingly, one object of the present invention is to provide a stable, relatively dry, free-flowing granule with neem oil contained therein. Another object of the present invention is to provide a neem oil granule that can be applied to crops by incorporating the granule into the soil. Yet another object of the present invention is to provide a neem oil granule for applying neem oil to plants or crops more effectively than current methods of spraying diluted neem oil directly onto plants. Furthermore, an object of the present invention is to provide a neem oil granule with slow release properties such that the pesticide granule is effective over an extended period of time, thereby requiring less frequent applications compared to current methods of spraying diluted neem oil directly onto plants.

### DESCRIPTION OF THE DRAWINGS

These and other features, aspects, and advantages of the present invention will become better understood with regard to the following description, appended claims, and accompanying drawing where:

FIG. 1 depicts a flow diagram of a method for producing a neem oil granule embodying features of the present invention.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, ingredients, steps, etc. are optionally present. For example, an article “comprising” components A, B, and C can contain only components A, B, and C, or can contain not only components A, B, and C, but also one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

A preferred embodiment of the invention is directed to a pesticide granule comprising neem oil. In order to manufacture and/or synthesize the granule, neem oil is applied onto a carrier granule. A drying agent is then applied to the exterior of the carrier granule that has been coated with neem oil, which comprises the active ingredient azadirachtin. This process produces a free-flowing granule having a relatively dry exterior even though the granule comprises neem oil. In a preferred embodiment, the granule further comprises a blend of nutrients and other ingredients beneficial to crops. The pesticide granule comprising neem oil is utilized in protecting plants by applying granules into seed furrows at the time of seed planting. The amount of granules applied depends on the type of plant being treated, the azadirachtin concentration in the granules, and other factors. The neem oil is stable on the granules in the granule packaging. In addition, the release of azadirachtin from the granules takes place over a prolonged period. In a preferred embodiment, it takes approximately one month to release substantially all of the azadirachtin contained within granules applied in a single application.

The neem oil utilized in manufacturing the granule is preferably cold pressed from neem seed kernels. The cold pressed neem oil comprises azadirachtin. The preferred cold pressed neem oil is provided by Georgia Organic Solutions, and branded as GOS NEEM 7-Way. However, it should be understood by one skilled in the art that the invention disclosed herein encompasses all forms of neem oil comprising azadirachtin, including neem oil obtained through solvent extraction.

Preferred carrier granules that may be utilized in the present invention include attapulgite granules, EcoGranules, and Biodac granules. Attapulgite granules are prepared from clay minerals, EcoGranules are manufactured from wood fiber, and Biodac granules are made from cellulose (recycled newspaper). Attapulgite granules are the most preferred of these three types of granules, though it should be understood by one skilled in the art that other types of carrier granules capable of carrying liquid neem oil may be utilized, including, but not limited to, humate granules, gypsum granules, or plant derived granules. The carrier granules utilized in the present invention are preferably biodegradable.

As used herein, the term “carrier granule” or any term referring to a specific type of carrier granule refers only to the carrier granules described above or similar granules that serve as a base to which neem oil may be applied. The terms “pesticide granule”, “neem oil granule”, or simply “granule”, as used herein, refer to the combination of carrier granule, neem oil, and other added materials including, but not limited to, drying agents or nutrients.

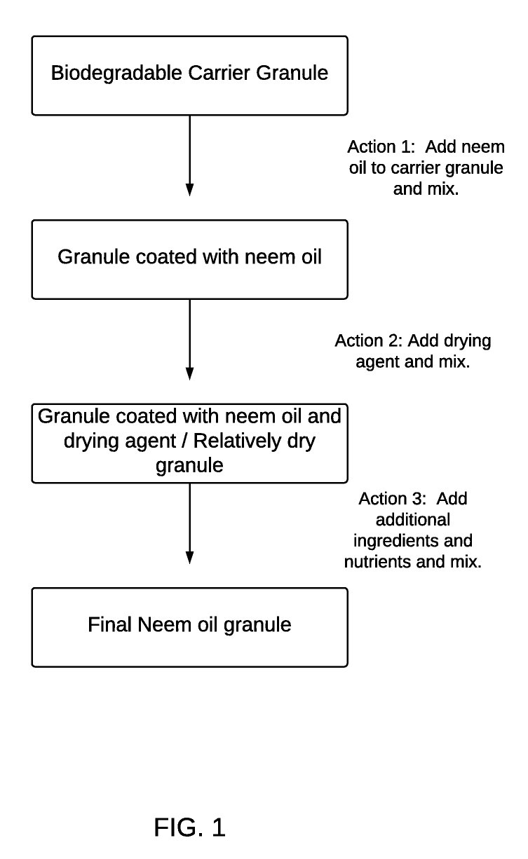

Methods of preparing the neem oil granules disclosed herein may take place with different techniques. FIG. 1 illustrates a preferred method of preparing the granule of the present invention. In this preferred embodiment, neem oil is first sprayed directly onto the carrier granules. Preferably, about 6 to 12 ounces (mass) of neem oil is sprayed per pound of carrier granules, and more preferably about 8 ounces of neem oil per pound of carrier granules. However, it should be understood that differing ratios of neem oil to carrier granules are encompassed in the present invention.

In an alternative embodiment, the neem oil may be mixed with acetone before spraying onto the granules. Because the neem oil may be viscous and difficult to spray, mixing the neem oil with acetone or a similar hydrophobic compound forms a solution that is less viscous and easier to spray onto the granules. The solution is preferably about 50% neem oil and about 50% acetone. The solution may be sprayed from an aerosol canister, preferably with a nitrogen propellant at about 140 psi. When sprayed from an aerosol canister, the spray is observed as a fine droplet mist. The acetone evaporates almost immediately upon spraying and does not leave behind an odor on the granules.

A rotating pan is preferably used in the process of spraying neem oil onto the carrier granules. As the neem oil is sprayed onto the carrier granules, the carrier granules tumble in the rotating pan in order to ensure even distribution of neem oil throughout the carrier granules. Once the oil is distributed on the granules, the resulting product tends to be tacky, and the separate granules may adhere to the rotating pan and to each other. Because the final product must be free-flowing granules having a relatively dry exterior, the granules coated with neem oil must be dried. The wet granules are dried by applying a drying agent to the granules.

In a preferred embodiment, the drying agent comprises hydrophobic synthetic amorphous silica. Many forms of commercially available synthetic silica may be utilized. One example of a preferred silica product is Aerosil R972, which is available as a silica powder. The amount of Aerosil R972 silica necessary is dependent on the type of carrier granule used. Using the method of granule production described above, it was found that attapulgite granules require an amount of Aerosil R972 silica equal to approximately 2.9% of the total weight of the granules in order to adequately coat the granules and give them relatively dry, free-flowing characteristics (the total weight includes the weight of carrier granules, neem oil, and silica). EcoGranules require approximately 16.6% Aerosil R972, and Biodac granules require approximately 9.5% Aerosil R972. Attapulgite granules are preferred for producing the final neem oil granules because they required the least amount of Aerosil R972. After applying the Aerosil R972, small yellow spheres of Aerosil R972 silica coated with neem oil were observed dispersed among the granules. The greater amount of silica used, the greater the number of spheres observed dispersed among the granules. Thus, the granule formulation comprising attapulgite granules produced the least amount of silica spheres with neem oil dispersed with the granules.

In an alternative embodiment, the Aerosil R972 is mixed with the carrier granules before adding the neem oil. Using this method, it was found that attapulgite granules require an amount of Aerosil R972 silica equal to approximately 4.5% of the total weight of the granules in order to adequately coat the granules and give them relatively dry, free-flowing characteristics after adding the neem oil. Using this method, EcoGranules require approximately 20% Aerosil R972, and Biodac granules require approximately 9.5% Aerosil R972.

An overall inventive concept disclosed herein is the addition of a drying agent to the neem oil granules. The addition of a drying agent not only produces a free-flowing granule but also helps to maintain neem oil adhesion to the granule. It is understood that silica or other drying agents may be utilized in the production of the granules. The exact concentration of the drying agent will be dependent on a variety of factors, including, but not limited to, the type of carrier granules, the type of drying agent, and the concentration of neem oil in the granules.

In another alternative embodiment, the drying agent is neem cake or neem powder, or a combination thereof. Neem cake is a by-product obtained from crushing neem seed kernels for the extraction of neem oil, and neem powder is produced by drying and grinding neem seeds, leaves, fruit, flowers, or combinations thereof. Preferably, the amount of neem cake and/or powder used is about one pound of cake/powder for every five pounds of granules sprayed with neem oil, or about 16.7% of the total weight of the granules. It is understood that more or less neem cake/powder may be mixed into the granules. The exact ratio will be dependent on the concentration of azadirachtin in the originally sprayed neem oil, the type of carrier granules, the intended purpose of the granules, the intended plants or crops to be treated, and other facts.

The neem cake and/or powder contains a number of nutrients and other ingredients beneficial to crops. Thus, the neem cake/powder functions not only as a drying agent but also as a nutrient blend. In a preferred embodiment, the neem cake and/or powder comprises (by weight) about 4% nitrogen, about 1% phosphorus, about 0.5% potassium, about 0.2% calcium, about 0.2% sulfur, about 8% magnesium, about 1300 ppm iron, about 520 ppm copper, about 304 ppm manganese, about 45 ppm boron, about 6 ppm molybdenum, about 2.6% organic carbon, and about 8% neem oil.

The exact percentages of the various macronutrients and micronutrients will depend on the specific batch of neem cake and/or powder. Therefore, it is understood that embodiments of the invention disclosed herein encompass various percentages of the macronutrients and micronutrients, as generally found in neem cake and/or powder, set forth above.

In the preferred embodiment in which silica is used as the drying agent, the blend of macronutrients and micronutrients composing neem cake/powder as described above, or a similar blend, may be created in a laboratory and added to the granules in addition to the silica or other drying agents. Similar to the neem cake and/or powder nutrient blend, this blend preferably comprises (by weight) about 4% nitrogen, about 1% phosphorus, about 0.5% potassium, about 0.2% calcium, about 0.2% sulfur, about 8% magnesium, about 1300 ppm iron, about 520 ppm copper, about 304 ppm manganese, about 45 ppm boron, about 6 ppm molybdenum, about 2.6% organic carbon, and about 8% neem oil. However, it should be understood that this nutrient blend may comprise any or all of the individual ingredients named above and/or differing concentrations of these ingredients.

In addition to the nutrient blend described above, the neem granules preferably comprise Ascophyllum nodosum (seaweed extract powder). This extract powder contains a number of important amino acids for plants and functions as an additional nutrient blend. The extract powder typically comprises (by weight) about 0.8-1.5% nitrogen, about 1-2% phosphoric acid, about 17-22% potassium, about 1-2% sulfur, about 0.2-0.6% magnesium, about 0.3-6% calcium, about 75-150 ppm boron, about 75-250 ppm iron, about 5-20 ppm manganese, about 1-5 ppm copper, and about 25-50 ppm zinc. The preferred amount of Ascophyllum nodosum to be added to the granules is about 1.5-6% of the total weight of the neem granules.

The exact percentages of the various macronutrients and micronutrients will depend on the specific batch of Ascophyllum nodosum. Therefore, it is understood that embodiments of the invention disclosed herein encompass various percentages of the macronutrients and micronutrients, as generally found in Ascophyllum nodosum, set forth above.

In a preferred embodiment of the invention, the neem granules further comprise about 1.5-6% by weight of Yucca schidigera extract. This extract contains high levels of steroidal saponins and serves as a surfactant.

In another preferred embodiment of the invention, the neem granules further comprise about 1.5-6% by weight of humic acid. In one embodiment, the humic acid may be derived from leonardite.

Any of the nutrient blends described above, in addition to the Yucca schidigera extract and the humic acid, may be added to the neem granules in several ways. These ingredients may be combined with the carrier granules before the addition of neem oil. Optionally, these ingredients may also be mixed with the silica or similar drying agents and added either before or after the addition of neem oil. A further option is to add these materials as the final step after the drying agent and neem oil have been added to the granules. As shown in FIG. 1, this is the preferred method of adding the additional nutrients and/or other ingredients.

In the embodiment utilizing neem cake and/or powder, the neem cake/powder serves as both a nutrient blend and as the drying agent. In this embodiment, the neem cake/powder may be combined with the carrier granules before the addition of neem oil, or may be added to the granules after the addition of neem oil.

A preferred embodiment of the invention comprises a biodegradable carrier granule (preferably attapulgite granules), neem oil, a silica-based drying agent (preferably Aerosil R972), Ascophyllum nodosum, Yucca schidigera extract, and humic acid. The amount of neem oil contained in the final pesticide granule product may range from about 10% to about 20% by weight, preferably from about 15% to about 18%, and more preferably from about 16% to about 17%.

Nevertheless, it is understood that embodiments of the invention set forth herein may comprise carrier granules of any type, including, but not limited to attapulgite granules, EcoGranules, or Biodac granules, in addition to neem oil, silica or other drying agents, neem cake, neem powder, Yucca schidigera extract, humic acid, and one or more nutrient blends, which preferably include Ascophyllum nodosum extract powder. Furthermore, different methods of dispersing neem oil onto the carrier granules are encompassed in embodiments of the invention disclosed herein. For instance, spraying neem oil onto carrier granules on a conveyer, dispersing carrier granules in baths of neem oil, and other similar methods of neem oil application are understood to fall within the subject matter of the neem oil granule and methods of producing the granule set forth herein.

What is claimed is:

1. A granular pesticide, comprising:
a. a plurality of carrier granules;
b. neem oil; and,
c. a drying agent.

2. The granular pesticide of claim 1, wherein the carrier granules are produced from attapulgite clay, wood fiber, cellulose, or plant fibers.

3. The granular pesticide of claim 1, comprising about 15% to about 18% neem oil by weight.

4. The granular pesticide of claim 1, wherein the drying agent is silica.

5. The granular pesticide of claim 4, comprising about 2% to about 20% silica by weight.

6. The granular pesticide of claim 1, wherein the drying agent is neem cake or neem powder.

7. The granular pesticide of claim 1, further comprising a nutrient composition comprising nitrogen, phosphorus, and potassium.

8. The granular pesticide of claim 7, wherein said nutrient composition comprises about 3% to about 5% nitrogen, about 0.5% to about 1.5% phosphorus, and about 0.2% to about 1% potassium by weight.

9. The granular pesticide of claim 7, wherein said nutrient composition further comprises calcium, sulfur, magnesium, iron, copper, manganese, boron, molybdenum, and organic carbon.

10. The granular pesticide of claim 1, further comprising about 1.5% to about 6% by weight seaweed extract.

11. The granular pesticide of claim 10, wherein the seaweed extract comprises about 0.8% to about 1.5% nitrogen, about 1% to about 2% phosphoric acid, about 17% to about 22% potassium, about 1% to about 2% sulfur, about 0.2% to about 0.6% magnesium, about 0.3% to about 6% calcium, about 75 ppm to about 150 ppm boron, about 75 ppm to about 250 ppm iron, about 5 ppm to about 20 ppm manganese, about 1 ppm to about 5 ppm copper, and about 25 ppm to about 50 ppm zinc by weight.

12. The granular pesticide of claim 1, further comprising about 1.5% to about 6% by weight of Yucca schidigera extract.

13. The granular pesticide of claim 1, further comprising about 1.5% to about 6% by weight of humic acid.

14. A granular pesticide, comprising:
a. a plurality of carrier granules;
b. about 15% to about 18% by weight neem oil;
c. about 2% to about 20% by weight of a drying agent comprising silica;
d. about 15% to about 20% by weight of a nutrient composition comprising nitrogen, phosphorus, and potassium;
e. about 1.5% to about 6% by weight seaweed extract;
f. about 1.5% to about 6% by weight of Yucca schidigera extract; and,
g. about 1.5% to about 6% by weight of humic acid.

15. The granular pesticide of claim 14, wherein the carrier granules are produced from attapulgite clay, wood fiber, or cellulose.

16. A method of manufacturing a granular pesticide, said method comprising the following steps:
a. providing a plurality of carrier granules;
b. applying neem oil to the granules; and,
c. applying a drying agent to the granules.

17. The method of claim 16, wherein neem oil is applied to the granules by spraying the neem oil onto the granules while the granules tumble in a rotating pan.

18. The method of claim 16, wherein the carrier granules are produced from attapulgite clay, wood fiber, or cellulose.

19. The method of claim 16, wherein the granular pesticide comprises about 15% to about 18% neem oil by weight.

20. The method of claim 16, wherein the drying agent is silica.

21. The method of claim 20, wherein the granular pesticide comprises about 2% to about 20% silica by weight.

22. The method of claim 16, further comprising the step of applying a nutrient composition to the granules, said nutrient composition comprising nitrogen, phosphorus, and potassium.

23. The method of claim 16, further comprising the step of applying seaweed extract to the granules.

24. The method of claim 16, further comprising the step of applying Yucca schidigera extract to the granules.

25. The method of claim 16, further comprising the step of applying humic acid to the granules.
